(19) United States
(12) Patent Application Publication
(10) Pub. No.: US 2009/0181448 A1
(43) Pub. Date: Jul. 16, 2009

(54) PERFUSION TYPE VASCULAR TISSUE BIOREACTOR WITH ROTARY AND STRETCHING FUNCTIONS

(75) Inventors: Yubo Fan, Beijing (CN); Yuanwen Zou, Chengdu (CN); Jinchuan Li, Chengdu (CN); Xuejin Huang, Chengdu (CN); Xianghui Gong, Beijing (CN)

Correspondence Address: LANIER FORD SHAVER & PAYNE P.C., P O BOX 2087, HUNTSVILLE, AL, 35804-2087, US

(73) Assignee: BEIJING UNIVERSITY OF AERONAUTICS & ASTRONAUTICS, Beijing (CN)

(21) Appl. No.: 12/344,586

(22) Filed: Dec. 28, 2008

(30) Foreign Application Priority Data
Dec. 28, 2007 (CN) 200710304557.4
Mar. 18, 2008 (CN) 200810102142.3
Mar. 18, 2008 (CN) 200810102143.8
Mar. 18, 2008 (CN) 200810102144.2
Mar. 18, 2008 (CN) 200810102145.7

(51) Int. Cl. A01N 1/02

(52) U.S. Cl. 435/284.1

(57) ABSTRACT

The present invention in one aspect provides a bioreactor for vascular construct that comprises a pulse-generating device with simple structure and reliable and stable pulse-generating operation. In another aspect, the present invention provides bioreactor for vascular construct that implements rotation of vascular construct and culture chamber, axial stretching of vascular construct, and duplicating pulsatile flow.

### FIELD OF THE INVENTION

The invention is generally in the field of tissue engineering, more specifically in the field of tissue engineering bioreactor for vascular constructs with rotary, stretching, and perfusion functions.

### BACKGROUND OF THE INVENTION

Coronary and peripheral artery bypass grafting is commonly used to relieve the symptoms of angina and other vascular deficiencies. To date, autograft, allograft blood vessels, vascular xenograft, and synthetic materials can not be an ideal substitute for small diameter (<6 mm) vascular grafts. Developing small diameter vascular grafts with high patency and durability as substitutes for the coronary and peripheral vasculature is a challenge for vascular tissue engineering.

In recent years, construct tissue-engineered vascular with bioreactor may bring prospect to this area. Firstly bioreactors can be custom designed to engineer tissues with complicated three-dimensional geometry containing multiple cell types. Secondly bioreactor can supply a controllable biochemical and mechanical environment to promote cell growth, maturation, and tissue differentiation. At last, bioreactors can serve as tissue growth systems as well as packaging and shipping units that can be delivered directly to surgeons. The research of tissue engineering bioreactor for vascular construct focus on the following aspects:

1. High-density cell seeding and uniform cell distribution on 3D scaffolds. High seeding density can enhance tissue formation, and uniform distribution of cells within the scaffold can significantly affect the tissue properties. Perfusion seeding has been reported to be a more effective way to improve both seeding efficiency and cell distribution than static seeding or the stirring-flasks bioreactor (2-20). Perfusion seeding bioreactors have been designed for engineering vascular grafts, cartilage, hepatocyte and cardiac tissues.

2. Increase of mass transport. The rotating wall bioreactor can generate dynamic flow to improve nutrients and wastes transfer and to provide a low stress. Research results have shown that properties of engineered tissue cultured in the rotating wall bioreactor were superior to those of static or stirring-flask bioreactor (2-30). As the effect of the rotating wall bioreactor depended on the perfusion rate, the sheer stress, the balance of nutrients and wastes transfer, design and optimize the rotating wall bioreactor match the needs of specific tissues is important

3. Mechanical stimulation. Many studies have shown that flow sheer stress had significant effect on endothelial cells; cyclical mechanical stretch was found to increase tissue organization and expression of elastin by smooth muscle cells seeded in polymeric scaffolds (2-52); pulsatile radial stress improved the mechanical strength of engineered blood vessels (2-53).

Yuji Narita et al. designed a non-rotary wall and perfusion bioreactor for vascular construct (Novel Pulse Duplicating Bioreactor System for Tissue-Engineered Vascular Construct. Tissue Engineering 2004; 10(7-8):1224-1233.), in which a balloon was immersed in liquid confined in a solid chamber. Inflation of the balloon was modulated by an air-pump device to cause pulse-like pressure variation in the liquid confined in the chamber and in liquid in pipeline connected to the chamber.

Craig A. Thompson et al. developed a perfusion bioreactor for vascular construct by using a mechanical ventilator to induce pulsatile, laminar flow into a fluid column. They claimed that their design can generate pressurized waveforms similar to mammalian physiology (A Novel Pulsatile, Laminar Flow Bioreactor for the Development of Tissue-Engineered Vascular Structures. Tissue Engineering 2002; 8(6): 1083-1088.).

Boris A. Nasseri et al. designed a rotating bioreactor for vascular construct to improve mass transfer. A hybridization oven was used for rotational seeding and culture. Culture vessel was placed in the hybrization oven and was rotated around the central axis (Dynamic Rotational Seeding and Cell Culture System for Vascular Tube Formation. Tissue Engineering 2003; 9(2): 291-299.).

Ralf Sodian et al. designed a non-rotating wall perfusion bioreactor for vascular construct (Tissue-Engineering Bioreactors: A New Combined Cell-Seeding and Perfusion System for Vascular Tissue Engineering. Tissue Engineering 2002; 8(5):863-870.), in which a pneumatic device was used to generate pulsatile flow.

Chrysanthi Williams et al. described a non-rotating wall bioreactor to culture small diameter arterial constructs. With two peristaltic pumps the bioreactor provided dual perfusion flow through the lumen and on the external surface of the constructs (Perfusion Bioreactor for Small Diameter Tissue-Engineered Arteries. Tissue Engineering 2004; 10 (5-6):930-941.). The internal perfusion provided sheer stress and pulsatile flow environment. The external perfusion improved mass transfer.

Satish, C. Muluk et al. designed a non-rotating wall bioreactor for vascular construct that implemented stretching of vascular tissue by a stretching motor and twisting of vascular tissue by a twisting motor (Enhancement of tissue factor expression by vein segments exposed to coronary arterial hemodynamics. Journal of vascular surgery: official publication, the Society for Vascular Surgery [and] International Society for Cardiovascular Surgery, North American Chapter 1998; 27(3):521-527). Vascular internal perfusion was implemented in this design.

In summary, the existing tissue engineering bioreactors for vascular construct have some limitations: First, they cannot use simple mechanical stimuli with little consideration on the blood flow impedance, vascular compliance, and vascular inertia resistance to reproduce a similar flow environment in vivo; second, periodical axial tensile, cyclical stretch, twisting, and sheer stress can not be imposed on vascular construct at the same time; third, the properties of seeding efficiency, uniform cell distribution, and mass transfer need to be improved. For these reasons, it is essential to develop bioreactor for vascular constructs, which can provide physiological pulsatile flow perfusion and multi-mechanical stimulation.

### SUMMARY OF THE INVENTION

The present invention is to provide a multi-module tissue engineering bioreactor for vascular construct of different length and diameter. Also it provides devices and methods for research on the cellular, histological and mechanical properties of vascular constructs. The present invention is characterized by the follows:

1. The bioreactor is developed to generate physiological pulsatile flow by mimic of the blood flow impedance, vascular compliance, and vascular inertia resistance in the flow loop. Pulsatile frequency, blood pressure, and flow waveform of different section of arterial 1 can be simulated in the bioreactor. The hemodynamic environment of high blood pressure, high sheer stress, and low sheer stress can also be simulated by adjusting the pulsatile waveforms, pressure, flow, and pulsatile frequency to a certain scope.

2. The bioreactor is developed to impose controllable periodical axial tension, cyclical stretch and twisting, similar to the mechanical environment in vivo at the same time or separately. To impose the axial tension, at least one of the inlet tube and the outlet tube should be provided on the drive rod of the linear stepping motor to do axial movement reciprocal.

3. The bioreactor is rotating-wall perfusion bioreactor for vascular construct. The vascular construct and the culture vessel can rotate at the same time or separately driven by rotary motor. The rotation speed and direction are controllable. The perfusion devices can perfuse culture media inside and outside the lumen at the same time or separately. So the bioreactor has a good mass transfer performance.

4. The bioreactor could have mentioned a particular function, or any combination of a number of functions, or including all of the above-mentioned functions at the same time.

### BRIEF DESCRIPTION OF THE DRAWINGS

FIG. 1 shows a non-limiting embodiment of the present invention for illustrating the principle and arrangement of intravascular physiological pulsatile perfusion flow loop of the present invention.

FIG. 2 shows a further non-limiting embodiment of the present invention, which comprises means for stretching vascular constructs to be cultured in the culture chamber.

FIG. 3 shows a further non-limiting embodiment of the present invention, which comprises means for effecting extra-vascular perfusion of vascular constructs to be cultured.

FIG. 4 shows a further non-limiting embodiment of the present invention, which allows for physiological pulsatile flow perfusion and rotation of the vascular construct and the culture chamber.

FIG. 5 shows a further non-limiting embodiment of the present invention, which, in addition to the functions realized by the embodiment shown in FIG. 4, allows stretching of vascular constructs cultured in the culture chamber.

### DESCRIPTION OF EMBODIMENTS

Detailed description of embodiments of the present invention is given below with reference to drawings, in which like reference numerals denote same or similar parts, and some repetitive description thereof is omitted.

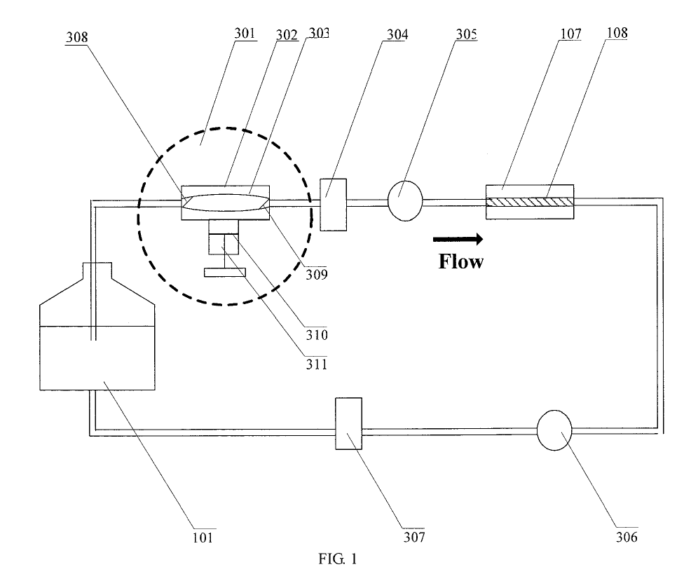

FIG. 1 shows a non-limiting embodiment of the present invention for illustrating the principle and arrangement of the pulsatile flow generator of the present invention. As shown in FIG. 1, a pulsatile flow generator 301, a first resistance adjustor 304, and a first compliance chamber 305 are serially connected by liquid pipeline between an internal perfusion media reservoir 101 and a vascular constructs culture chamber 107.

As shown in FIG. 1, a pulsatile flow generator 301 of the present invention comprises a pulsation cavity 302, an elastic soft tube 303 that goes through cavity 302, an upstream one-way valve 308 provided at the upstream port of tube 303, a downstream one-way valve 309 provided at the downstream port of tube 303, a seal piston 310, and a linear motion actuator 311 for driving piston 310. Pulsation cavity 302 is a sealable cavity with a constant volume to be filled with liquid. Elastic soft tube 303 constitutes the part of the internal perfusion loop within pulsation cavity 302. Elastic soft tube 303 is arranged in such a way that liquid within elastic soft tube 303 is separated from liquid filling cavity 302, that is, there is no liquid exchange between the liquid filling cavity 302 and the liquid flowing through elastic soft tube 303. On the other hand, the elasticity of the wall of tube 303 allows variation in pressure of the liquid filling cavity 302 to be transmitted to the liquid flowing through elastic soft tube 303. Reciprocal movement of linear motion actuator 311 acts, by piston 310, on the liquid filling cavity 302 and in turn on the culture liquid flowing through elastic soft tube 303, thereby generating a corresponding pulsatile flow in the intravascular perfusion loop.

As a preferred but non-limiting embodiment, such a pulsatile flow can be made to simulate the ejection of blood into aorta, etc., and the pulsatile frequency, flow rate, and/or pressure can be adjusted. One-way valves 308 and 309 ensure that the flow of culture liquid out of pulsatile flow generator 301 is unidirectional.

Reference numeral 304 denotes a first resistance adjustor. A resistance adjustor is a mechanical adjusting device, such as an adjusting valve, provided on a section of pipe for adjusting the flow rate of liquid flowing through the pipe, which is accompanied by adjustment of perfusion pressure in the pipe.

Reference numeral 305 denotes a first compliance chamber. A compliance chamber is for adjusting the variation in the liquid volume resulting from pressure variation.

Reference numeral 306 denotes a second compliance chamber. Reference numeral 307 denotes a second resistance adjustor.

Each of first and second resistance adjustors 304 and 307 is for adjusting perfusion pressure and waveform and/or amplitude of variation of perfusion pressure in the vascular construct 108. Each of first and second compliance chambers 305 and 306 is for adjusting flow inertia of culture liquid in the vascular construct 108. In an embodiment of the present invention, first and second resistance adjustors 304 and 307 and first and second compliance chambers 305 and 306 are used to obtain a physiological pulsatile flow, with its waveform, dicrotic wave, amplitude, and/or time phase, and/or to obtain the hemodynamic environment of high blood pressure, high sheer stress similar to hypertension, and to obtain the hemodynamic environment of low pressure, low sheer stress similar to hypotension.

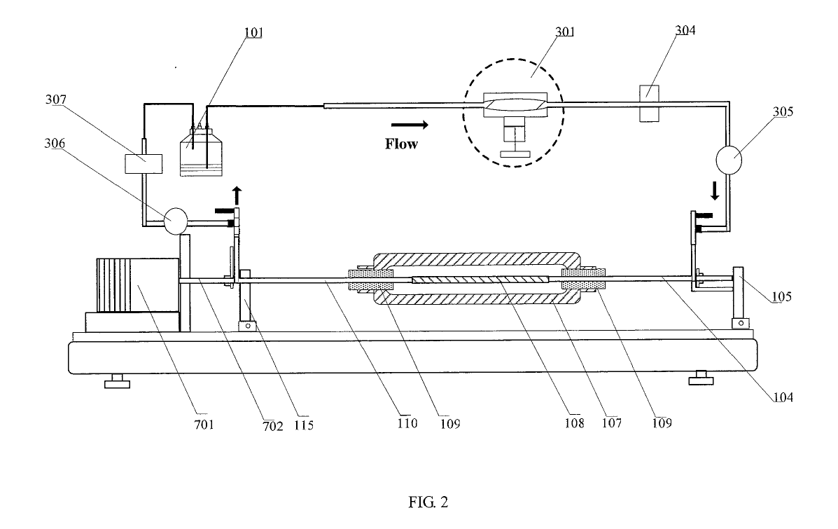

FIG. 2 shows a further non-limiting embodiment of the present invention. Comparing with the embodiment shown in FIG. 1, the embodiment of FIG. 2 further comprises a section for stretching vascular construct being cultured in culture chamber.

As shown in FIG. 2, reference numeral 105 denotes an upstream supporting frame of intravascular perfusion loop, reference numeral 104 denotes a culture chamber inlet pipe of intravascular perfusion loop. Reference numeral 110 denotes a culture chamber outlet pipe of intravascular perfusion loop. Reference numeral 702 denotes a driving rod of a stretching motor. Reference numeral 115 denotes a downstream supporting frame of intravascular perfusion loop. Reference numeral 701 denotes a stretch motor.

As a non-limiting embodiment, culture chamber outlet pipe 110 fits with a downstream sealing plug 109 in a slidable way. The reciprocal stretching of driving 702 of stretch motor 701 acts on outlet pipe 110, making outlet pipe 110 to perform axial reciprocal movement, thereby realizing reciprocal stretching of vascular construct 108 being cultured.

Culture chamber 107 is preferably made with sterilization-tolerant material (such as glass, plastic, stainless steel, polycarbonate) to provide a sealed sterile environment for vascular construct to be cultured. During culture process of vascular construct, culture chamber 107 may be completely or partly filled with culture media; said culture media may be the same as the culture media flowing through the interior of vascular construct 108.

With an embodiment as shown in FIG. 2, axial reciprocal stretching of vascular construct 108 cultured and pulsatile flow perfusion in vascular construct 108 can be realized simultaneously.

It should be understood that the arrangement of stretching motor 701 as shown in FIG. 2 is not unique; and stretching motor 701 can be provided at the upstream side of culture chamber 107 and/or coupled to culture chamber inlet pipe 104 to obtain the same or equivalent effects.

Further, stretching motor 701 is not the only way to effect reciprocal movement of vascular construct 108, and it can be replaced by other devices, such as a crank-connecting rod mechanism, a hydraulic cylinder, or etc.

All variations such as these are within the scope of the present invention.

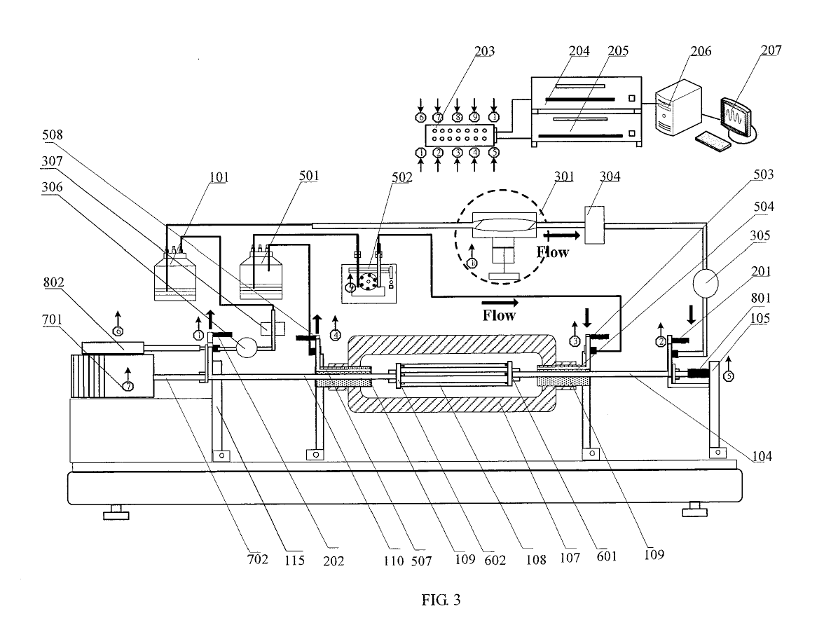

FIG. 3 shows a further non-limiting embodiment of the present invention, which, as compared with the embodiment of FIG. 2, further comprises parts for effecting extra-vascular perfusion of vascular construct 108.

The downstream end of culture chamber inlet pipe 104 of intravascular perfusion loop is provided inside culture chamber 107. Reference numeral 601 denotes an optional upstream adaptor, which is connected to the downstream end of inlet pipe 104. The upstream ends of a plurality of vascular constructs 108 to be cultured can be fitted on upstream adaptor 601, thereby realizing simultaneous culturing of a plurality of vascular constructs.

The downstream ends of vascular constructs 108 to be cultured can be fitted on a downstream adaptor 602, which is connected to the upstream end of culture chamber outlet pipe 110 of the intravascular perfusion loop, while the downstream end of outlet pipe 110 is provided outside of culture chamber 107 and connects with a pipeline section leading to reservoir 101, thus forming a closed intravascular perfusion loop.

In FIG. 3, reference numeral 109 denotes sealing plugs for allowing inlet pipe 104 and outlet pipe 110 to enter into and/or to come out of culture chamber 107 respectively in a sealed way.

A non-limiting embodiment as shown in FIG. 3 further comprises an upstream supporting frame 105 and a downstream supporting frame 115 of intravascular perfusion loop; these frames are for supporting and/or holding inlet pipe 104 and outlet pipe 110, respectively.

An embodiment as shown in FIG. 3 further comprises parts for collecting, processing, displaying and/or recording data; one embodiment as shown in FIG. 3 comprises: a pressure sensor 201 provided at the inlet of culture chamber for sensing the pressure at the inlet of culture chamber 107 in intravascular perfusion loop; a stretching sensor 801 for detecting stretching force acted on inlet pipe 104; a displacement sensor 802 provided on the stretching motor for sensing a stretching amount of vascular construct 108; a hub 203 for receiving outputs of sensors 202 and 802; signal amplifier 204 for receiving outputs of sensors 202 and 802 from hub 203 and amplifying them; a driver 205; a processor 206, which may be a PC or an IPC; and, a display 207.

As shown in FIG. 3, parts for effecting extra-vascular perfusion comprises: an extra-vascular perfusion media reservoir 501, an extra-vascular perfusion liquid driving device 502 connecting to media reservoir 501 via liquid pipeline, an extra-vascular perfusion loop culture chamber inlet pipe 504, which penetrates upstream sealing plug 109 and enters into culture chamber 107 for introducing culture liquid into culture chamber 107 from extra-vascular perfusion media reservoir 501, and a culture chamber exit pipe 507 of extra-vascular perfusion loop, which penetrate a downstream sealing plug 109 for discharging culture liquid from culture chamber 107.

An embodiment as shown in FIG. 3 can further comprises a culture chamber inlet pressure sensor 503 of extra-vascular perfusion loop and a culture chamber exit pressure sensor 508 of extra-vascular perfusion loop, for sensing liquid pressures at the inlet and exit of culture chamber of extra-vascular perfusion loop, respectively. Outputs of sensors 503 and 508 are sent to hub 203, processed by processor 206, and/or displayed by display 207, etc.

With an embodiment as shown in FIG. 3, extra-vascular perfusion in culture chamber is realized.

With an embodiment as shown in FIG. 3, intravascular perfusion (physiological perfusion), extra-vascular perfusion, stretching of vascular construct(s), and any combination of these functions/effects can be realized simultaneously or separately.

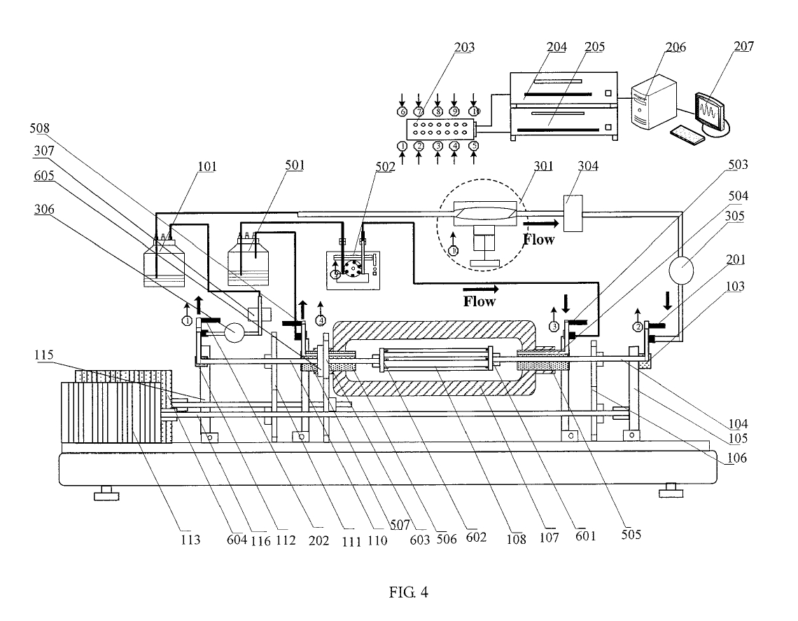

FIG. 4 shows a non-limiting embodiment of vascular construct bioreactor of the present invention. Details of such an embodiment are described below.

As shown in FIG. 4, an intravascular perfusion media reservoir 101 is connected to a pulsatile flow generator 301 by a pipe section.

The non-rotary pipe section at the downstream of pulsatile flow generator 301 is connected to the upstream end of rotary culture chamber inlet pipe 104 by an upstream coupling joint 103 of intravascular perfusion loop. Coupling joint 103 realizes a sealed connection between rotary inlet pipe 104 and the non-rotary pipeline leading to pulsatile flow generator 301.

The downstream end of inlet pipe 104 is provided inside culture chamber 107. In a non-limiting embodiment as shown in FIG. 4, an upstream adaptor 601 connecting to the downstream end of inlet pipe 104 is provided, and a downstream adaptor 602 connecting to the upstream end of outlet pipe 110 is provided. The upper end of each of vascular constructs 108 to be cultured is fitted on upstream adaptor 601.

The downstream end of each of vascular constructs 108 is fitted on downstream adaptor 602. The upstream end of outlet pipe 110 is provided inside culture chamber 107, and the downstream end of outlet pipe 110 is provided outside of culture chamber 107 and connects, by a downstream coupling joint 112 of intravascular perfusion loop, to non-rotary pipeline leading to media reservoir 101, thus forming a complete intravascular perfusion loop. Downstream coupling joint 112 effects a sealed connection between rotary outlet pipe 110 and the non-rotary pipeline leading to media reservoir 101.

As shown in FIG. 4, reference numerals 505 and 506 denote sealing plugs for allowing inlet pipe 104 and outlet pipe 110 to enter/exit culture chamber 107 respectively in a sealed manner.

In a non-limiting embodiment as shown in FIG. 4, reference numeral 113 denotes a vascular construct rotation driving motor. Shaft 116 of motor 113 is coupled to an upstream transmission gear set 106 and a downstream transmission gear set 111, so as to drive gear sets 106 and 111 to perform synchronized rotation. Gear set 106 is also coupled to inlet pipe 104, and gear set 111 is also coupled to outlet pipe 110, so rotation of gear set 106 drives inlet pipe 104 to rotate, and rotation of gear set 111 drives outlet pipe 110 to rotate, and the rotation of inlet pipe 104 is synchronized with the rotation of outlet pipe 110, thus resulting in rotation of vascular construct(s) 108 provided between inlet pipe 104 and outlet pipe 110.

An embodiment as shown in FIG. 4 further comprise parts for implementing independent rotation of culture chamber, which parts include a culture chamber rotary motor 604, a culture chamber rotary transmission gear set 603 coupled to the shaft of motor 604. Gear set 603 is further coupled to culture chamber 107 to transmit rotary driving force of motor 604 to culture chamber 107. In a non-limiting embodiment of this coupling as shown in FIG. 4, a follower gear of gear set 603 is fixedly mounted on a collar 605 of culture chamber 107 to transmit the driving force of motor 604 to culture chamber 107. In an embodiment as shown in FIG. 4, the joining between culture chamber 107 and sealing plugs 505 and 506 respectively is sealed and allows for relative rotation between culture chamber 107 and sealing plugs 505 and 506 respectively.

With an embodiment as shown in FIG. 4, simultaneous and/or independent rotations of vascular construct and culture chamber can be implemented; in addition, separate rotation of vascular construct or culture chamber and/or different rotation combinations and rotation mode switching can be implemented. Therefore, more effective, uniform, and/or more effective media transfer can be provided to vascular construct(s) being cultured.

It is to be noted that while two motors 113 and 604 are shown in FIG. 4 for driving vascular construct and culture chamber respectively, the present invention is not limited to this. For example, a single motor with a clutch/transmission mechanism can be used to implement separate rotational driving of vascular construct(s) and culture chamber and/or various rotational driving modes. Such a modification is clearly within the scope of the present invention.

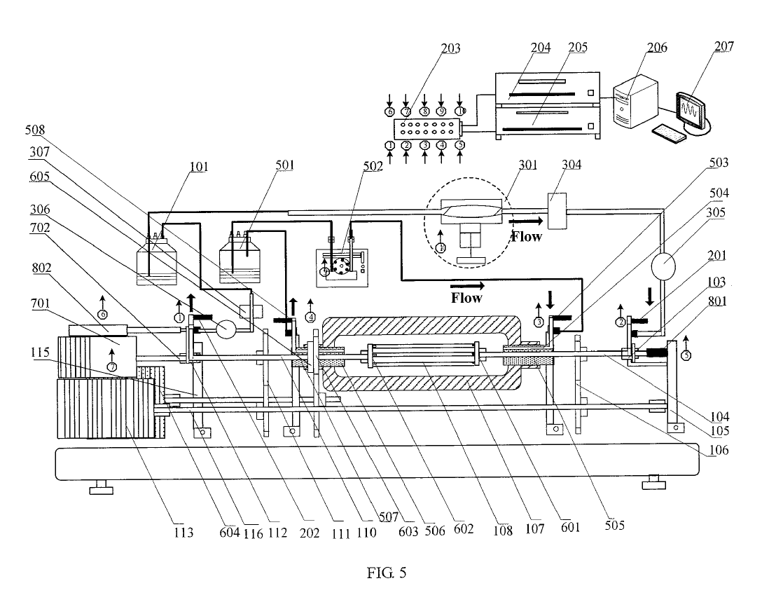

FIG. 5 shows a further embodiment of the present invention, which, as compared with an embodiment as shown in FIG. 4, further comprises parts for effecting stretching of vascular construct being cultured.

In an embodiment as shown in FIG. 5, culture chamber outlet pipe 110 fits with downstream sealing plug 506 in a slidable way. The reciprocal stretching of driving 702 of stretch motor 701 acts on outlet pipe 110, driving outlet pipe 110 to perform axial reciprocal movement, thereby realizing reciprocal stretching of vascular construct 108 being cultured.

Here, downstream transmission gear set 111 may accommodate its reciprocal axial movement relative to outlet pipe 110 in a variety of ways.

A first way is that outlet pipe 110 is axially fixed with respect to the gear, which directly couples to outlet pipe 110, of gear set 111, and reciprocal axial movement of outlet pipe 110 is absorbed by axial sliding between gears of gear set 111. for this, an optional arrangement is that one of the two gears in gear set 111, between which sliding occurs, has a obviously greater thickness than that of the other one of the two gears, so that disengagement between the two gears due to sliding between them is avoided.

A second way is that outlet pipe 110 is axially slidable with respect to the gear in gear set 111 that directly coupled to outlet pipe 110, and a supporting brace (not shown) is used to axially fix the gear.

With an embodiment as shown in FIG. 5, stretching of vascular constructs can be implemented in addition to internal and extra-vascular perfusion.

It is to be noted that arrangement of stretching mechanism is symmetrical with respect to inlet pipe 104 and outlet pipe 110, that is, the stretching drive of stretching motor 701 can either be coupled to outlet pipe 110 as shown in FIG. 5 or be coupled to inlet pipe 104. These two alternatives belong to the scope of the present invention.

With an embodiment as shown in FIG. 5, rotation of vascular construct, rotation of culture chamber, perfusion (or physiological perfusion) inside and/or outside the lumen, stretching of vascular construct (s), and any combination of these functions/effects can be realized simultaneously or separately.

It should be understood that gear sets 106, 111 and 603 are only exemplary for implementing corresponding rotary transmission devices. Other transmission mechanisms, such as chain transmission mechanism, belt transmission mechanism, rod transmission mechanism and etc., can be used to replace gear sets 106, 111, and/or 603.

### Example

### Intravascular and Extra-Vascular Perfusions with Vascular Construct Stretching, Vascular Construct Rotation and Culture Chamber Rotation

1. Intravascular and extra-vascular perfusion loops were arranged as shown in FIG. 5, a pulsatile flow generator of the present invention was used as intravascular perfusion liquid driving device, and a peristaltic pump was used as extra-vascular perfusion liquid driving device (Cole-Parmer, Masterflex series);

2. sterilization was performed on the bioreactor at 121□ (1 atm) for 1 hour;

3. vascular constructs to be cultured were fitted to upstream and downstream adaptors in the culture chamber under aseptic conditions, the scaffold of the construct is 6 mm in diameter and 20 cm in length and made of PLGA.

4. vascular construct rotation mechanism and culture chamber rotation mechanism were arranged as shown by FIG. 5, where the vascular construct rotation motor was a Haydon 57000 series linear step motor and the culture chamber rotation motor was a Haydon 57000 series linear step motor;

5. pressure sensor at the inlet and outlet of culture chamber of intravascular and extra-vascular perfusion loops and signal detecting devices were arranged as shown by FIG. 5;

6. Vascular construct stretching device were arranged as shown by FIG. 5, where the stretching device comprised a Haydon 57000 series step motor;

7. tension-compression sensor and displacement sensors were arranged as shown by FIG. 5;

8. culture medium was prepared as required; aseptic culture medium was filled into reservoirs;

9. each of the devices was powered-on;

10. pulsation frequency in lumen was set at 70 time/min., motor gain was set at 1-5%, and initial position was set; perfusion flow rate in lumen was set at 0-1.6 ml/s, inlet pressure was set at 100-140 mmHg, outlet pressure at 75-115 mmHg; perfusion flow rate outside the lumen was set at 0-1.0 ml/s, inlet pressure was set at 100-140 mmHg, outlet pressure at 85-110 mmHg;

11. rotation speed and direction of the vascular construct rotation motor were set as: anti-clockwise, 10 rpm; rotation speed and direction of the culture chamber rotation motor were set as: clockwise, 20 rpm;

12. periodic stretch stress on vascular constructs was set at 10N, and stretching frequency was set at 60 times/min.;

13. operation of the bioreactor was started;

14. resistance adjustors and compliance chambers were adjusted to control the pressure and waveform in vascular construct to simulate the artery pulse waveform similar to mammalian physiology.

We claim:

1. a bioreactor for vascular construct, comprising:
an intravascular perfusion media reservoir (101), a pulsatile flow generator (301), and a culture chamber inlet pipe (104) of intravascular perfusion loop, connected sequentially by liquid pipeline;
a culture chamber (107),
a culture chamber outlet pipe (110) of intravascular perfusion loop,
wherein the upstream end of said outlet pipe is provided inside said culture chamber for connection to the downstream end of at least one vascular construct to be cultured,
wherein the downstream end of said inlet pipe (104) is provided inside said culture chamber (107) for connection to the upstream end of said at least one vascular construct to be cultured,
a stretching device (701) mechanically coupled to one of said inlet pipe (104) and said outlet pipe (110), for making said one of said inlet pipe (104) and said outlet pipe (110) perform a reciprocal axial movement.

2. A bioreactor for vascular construct of claim 1, wherein said pulsatile flow generator comprises:
a pulsation cavity (302),
an elastic soft tube (303) going through said pulsation cavity (302) and forming the part of said intravascular perfusion loop within said pulsation cavity (302),
wherein said elastic soft tube is arranged in such a way that liquid within elastic soft tube 303 is separated from liquid filling cavity 302,
an upstream one-way valve (308) provided at the upstream port of said soft tube (303),
an upstream one-way valve (309) provided at the upstream port of said soft tube (303),
a seal piston (310) which can act on the liquid within said pulsation cavity, and
a linear motion actuator (311) coupled to said piston (310) for driving a linear motion of said piston (310), thereby generating a pulsatile flow in said intravascular perfusion loop.

3. A bioreactor of claim 2, further comprising:
a first resistance adjustor (304) provided at the downstream side said pulsatile flow generator (301), for adjusting perfusion pressure and waveform and/or amplitude of variation of perfusion pressure in the vascular construct (108);
a first compliance chamber (305) provided between said first resistance adjustor and said culture chamber, for adjusting flow inertia of in said vascular construct;
a second compliance chamber (306) provided at the downstream side of said culture chamber, for adjusting flow inertia in said vascular construct;
a second resistance adjustor (307) provided at the downstream side of said second compliance chamber (306), for adjusting perfusion pressure and waveform and/or amplitude of variation of perfusion pressure of in said vascular construct.

4. A bioreactor of claim 3, further comprising:
an extra-vascular perfusion media reservoir (501),
an extra-vascular perfusion liquid driving device (502) connecting to said extra-vascular perfusion media reservoir (501) via liquid pipeline,
an extra-vascular perfusion loop culture chamber inlet pipe (504), which connects to said extra-vascular perfusion liquid driving device (502) and enters into said culture chamber (107) for introducing culture media from said extra-vascular perfusion loop media reservoir into space within said culture chamber but outside said vascular construct (108), and
a culture chamber exit pipe (507) of extra-vascular perfusion loop, the upstream end of which is provided inside said culture chamber and the downstream end of which is provided outside of said culture chamber so as to discharging culture media from said culture chamber.

5. a bioreactor of claim 1, wherein said stretching device (701) is a linear motion actuator.

6. a pulsatile flow generator (301) as a liquid driving device of culture media in a bioreactor for vascular construct, said bioreactor for vascular construct comprises:
a intravascular perfusion media reservoir (101) provided at the upstream side of said pulsatile flow generator (301) and connecting to said pulsatile flow generator via liquid pipeline,
a culture chamber inlet pipe (104) of intravascular perfusion loop provided on the downstream side of said pulsatile flow generator and connecting to said pulsatile flow generator;
a vascular tissue culture chamber (107),
a culture chamber outlet pipe (110) of intravascular perfusion loop,
wherein the upstream end of said outlet pipe is provided inside said culture chamber for connection to the downstream end of at least one vascular construct to be cultured,
wherein the downstream end of said inlet pipe (104) is provided inside said culture chamber (107) for connection to the upstream end of said at least one vascular construct to be cultured,
wherein said pulsatile flow generator comprises:
a pulsation cavity (302) for being filled with liquid,
an elastic soft tube (303) going through said pulsation cavity (302) and forming the part of said intravascular perfusion loop within said pulsation cavity (302),
an upstream one-way valve (308) provided at the upstream port of said soft tube (303),
an upstream one-way valve (309) provided at the upstream port of said soft tube (303),
a seal piston (310) which can act on the liquid within said pulsation cavity, and
a linear motion actuator (311) coupled to said piston (310) for driving a linear motion of said piston (310), thereby generating a pulsatile flow in said intravascular perfusion loop.

7. a pulsatile flow generator of claim 6, wherein said bioreactor further comprises:
a first resistance adjustor (304) provided at the downstream side said pulsatile flow generator (301), for adjusting perfusion pressure and waveform and/or amplitude of variation of perfusion pressure in the vascular construct (108);
a first compliance chamber (305) provided between said first resistance adjustor and said culture chamber, for adjusting flow inertia of culture liquid in said vascular construct;
a second compliance chamber (306) provided at the downstream side of said culture chamber, for adjusting flow inertia of culture liquid in said vascular construct;
a second resistance adjustor (307) provided at the downstream side of said second compliance chamber (306), for adjusting perfusion pressure and waveform and/or amplitude of variation of perfusion pressure in vascular construct (107).

8. a bioreactor for vascular construct, comprising:
an intravascular perfusion liquid media reservoir (101), a pulsatile flow generator (301), and a culture chamber inlet pipe (104) of intravascular perfusion loop, connected sequentially by liquid pipeline;
a vascular tissue culture chamber (107);
a culture chamber outlet pipe (110) of intravascular perfusion loop,
wherein the upstream end of said outlet pipe is provided inside said culture chamber for connection to the downstream end of at least one vascular construct to be cultured,
wherein the downstream end of said inlet pipe (104) is provided inside said culture chamber (107) for connection to the upstream end of said at least one vascular construct to be cultured,
a vascular construct rotation driving motor (113);
an upstream transmission gear set (106) coupled to the shaft (116) of said vascular construct rotation driving motor (113) and said inlet pipe (104);
a downstream transmission gear set (111) coupled to the shaft (116) of said vascular construct rotation driving motor (113) and said outlet pipe (110);
wherein each of said inlet pipe (104) and said outlet pipe (110) is arranged to be rotatable around its axis.

9. A bioreactor of claim 8, further comprising.
an extra-vascular perfusion liquid media reservoir (501),
an extra-vascular perfusion liquid driving device (502) connecting to said extra-vascular perfusion liquid media reservoir (501) via liquid pipeline,
an extra-vascular perfusion loop culture chamber inlet pipe (504), the upstream end of which connects to said extra-vascular perfusion media driving device (502) and the downstream end of which is provided inside said culture chamber (107) for introducing culture media from said extra-vascular perfusion loop media reservoir into space within said culture chamber but outside said vascular construct (108),
a culture chamber exit pipe (507) of extra-vascular perfusion loop, the upstream end of which is provided inside said culture chamber (107) and the downstream end of which is provided outside of said culture chamber for discharging culture media from said culture chamber,
a culture chamber rotary motor 604, and
a culture chamber rotary transmission means (603) coupled to the shaft of said motor (604) and said culture chamber (107) for transmitting rotary driving force of said motor (604) to said culture chamber (107).

10. A bioreactor for vascular construct of claim 8, wherein said pulsatile flow generator comprises:
a pulsation cavity (302) for being filled with liquid;
an elastic soft tube (303) going through said pulsation cavity (302) and forming the part of said intravascular perfusion loop that is within said pulsation cavity (302),
an upstream one way valve (308) provided at the upstream port of said soft tube (303)
a downstream one-way valve (309) provided at the downstream port of said soft tube (303);
a seal piston (310) which can act on the liquid within said pulsation cavity; and
a linear motion actuator (311) for making said piston (310) perform a reciprocal motion and acting via said piston (310) on liquid filling said cavity and in turn on the culture media flowing through said elastic soft tube (303), thereby generating a pulsatile flow in said intravascular perfusion loop.

11. a bioreactor for vascular construct of claim 8, further comprising:
a stretching device (701) mechanically coupled to one of said inlet pipe (104) and said outlet pipe (110), for making said one of said inlet pipe (104) and said outlet pipe (110) perform reciprocal axial movement.

12. A bioreactor for vascular construct of claim 8, further comprising:
an upstream coupling joint (103) for effecting a seal connection of said rotatable inlet pipe (104) to a non-rotary section of liquid pipeline at the upstream side of said inlet pipe (104);
a downstream coupling joint (112) for effecting a seal connection of said rotatable outlet pipe (110) to a non-rotary section of liquid pipeline at the downstream side of said outlet pipe (110);
an upstream adaptor (601) connecting to the downstream end of said inlet pipe (104);
a downstream adaptor (602) connecting to the upstream end of said outlet pipe (104);
wherein said upstream and downstream adaptors (601, 602) are suitable for having a plurality of vascular constructs to be arranged between them.

13. a bioreactor for vascular construct of claim 11, wherein
said stretching device is a linear motor actuator,
said culture chamber (107) comprises a collar (605),
said culture chamber rotary transmission means (603) is a gear set (603), a follower gear of which is fixed on said collar (605).

14. A bioreactor for vascular construct of claim 10, further comprising:
a first resistance adjustor (304) provided downstream said pulsatile flow generator (301), for adjusting perfusion pressure and waveform and/or amplitude of variation of perfusion pressure in vascular construct (108);
a first compliance chamber (305) provided between said first resistance adjustor and said culture chamber, for adjusting flow inertia in said vascular construct;
a second compliance chamber (306) provided downstream said culture chamber, for adjusting flow inertia in said vascular construct;
a second resistance adjustor (307) provided downstream said second compliance chamber (306), for adjusting perfusion pressure and waveform and/or amplitude of variation of perfusion pressure in said vascular construct.
